(19) United States
(12) Patent Application Publication
(10) Pub. No.: US 2013/0001487 A1
(43) Pub. Date: Jan. 3, 2013

(54) INSULATED PINCH BAR

(76) Inventors: Joseph Fiorini, Hopewell Jct, NY (US); Anthony Liguori, Brewster, NY (US)

(21) Appl. No.: 13/172,540

(22) Filed: Jun. 29, 2011

(51) Int. Cl. B66F 3/00; H01B 19/00

(52) U.S. Cl. 254/120; 29/887

(57) ABSTRACT

Electrically-insulated utility devices and methods for using the same are described. In particular, this application discusses systems and methods for making and using electrically insulated pinch bars. Generally, each insulated pinch bar includes a pinch bar, which has a longitudinal body, a distal tip and a proximal head, and an electrically insulative material disposed circumferentially about a portion of the longitudinal body of the pinch bar. In some embodiments, the electrically insulative material also abuts the proximal head of the pinch bar. The insulated pinch bar can therefore provide safety for the pinch bar user or operator when the pinch bar is used in a variety of utility or construction applications and comes in contact with an electrical current. The insulated pinch bar can be part of a system which further includes a cover adapted to protect the electrically insulative material when the insulated pinch bar is not in use. Other embodiments are described.

### FIELD

This application relates generally to electrically-insulated utility devices. More specifically, this application relates to an electrically-insulated pinch bars and methods for making and using the same.

### BACKGROUND

Pinch bars are known as a lever with a pointed tip or end that are often used in utility applications. For instance, pinch bars are often used to facilitate the removal of manhole covers. Pinch bars can also be used, for example, as a lever to facilitate rolling heavy utility pipes in order to place such pipes in a desired location. Likewise, pinch bars are frequently used as a lever to manipulate the location of heavy thick steel plates used to temporarily cover holes or trenches in a pavement surface during the placement or maintenance of utility lines. Additionally, pinch bars are often used in concert with either an automated or a manual driving and/or extracting mechanism to place exploration or pilot holes through a pavement surface. For example, when a subsurface utility line (such as a gas line) develops a leak, a pinch bar can be repeatedly driven through a paved surface and into the subsurface soil at discrete locations to create a series of holes down which sensors are placed in order to gather readings or measurements and thereby pinpoint the precise location of the leak.

### SUMMARY

This application relates to electrically-insulated utility devices and methods for using the same. In particular, this application discusses systems and methods for making and using electrically insulated pinch bars. Generally, each insulated pinch bar includes a pinch bar, which has a longitudinal body, a distal tip and a proximal head, and an electrically insulative material disposed circumferentially about a portion of the longitudinal body of the pinch bar. In some embodiments, the electrically insulative material also abuts the proximal head of the pinch bar. The insulated pinch bar can therefore provide safety for the pinch bar user or operator when the pinch bar is used in a variety of utility or construction applications and comes in contact with an electrical current. The insulated pinch bar can be part of a system which further includes a cover adapted to protect the electrically insulative material when the insulated pinch bar is not in use.

### BRIEF DESCRIPTION OF THE DRAWINGS

The following description can be better understood in light of the Figures, in which:

FIG. 1 shows a plan view of some embodiments of an insulated pinch bar;

FIG. 2 shows an axial view of some embodiments of the insulated pinch bar;

FIG. 3 shows an axial view of some alternative embodiments of the insulated pinch bar;

FIG. 4 shows an enlarged plan view of a portion of some embodiments of the insulated pinch bar;

FIG. 5 shows a plan view of other embodiments of an insulated pinch bar;

FIG. 6 shows a plan view of alternative embodiments of an insulated pinch bar;

FIG. 7 shows a plan view of yet other embodiments of an insulated pinch bar;

FIG. 8 shows a plan view of some embodiments of a cover adapted to protect a portion of a pinch bar; and

FIG. 9 shows another plan view of some alternative embodiments of a cover adapted to protect a portion of a pinch bar.

The Figures illustrate specific aspects of the insulated pinch bars and methods for making and using the same. Together with the following description, the Figures demonstrate and explain the principles of the structures, methods, and principles described herein. In the drawings, the thickness and size of components may be exaggerated or otherwise modified for clarity. The same reference numerals in different drawings represent the same element, and thus their descriptions will not be repeated.

### DETAILED DESCRIPTION

The following description supplies specific details in order to provide a thorough understanding. Nevertheless, the skilled artisan would understand that the described insulated pinch bar and associated methods of making and using the insulated pinch bar can be implemented and used without employing these specific details. Indeed, the insulated pinch bar and associated methods can be placed into practice by modifying the illustrated devices and methods and can be used in conjunction with any other apparatus and techniques conventionally used in the industry. For example, while the description below focuses on methods for making and using an insulated pinch bar for facilitating the detection of a gas leak, the insulated pinch bar can be used in virtually any scenario where an electrically insulated mechanism is helpful or necessary.

Pinch bars are frequently constructed of electrically conductive materials, such as metallic materials. As a result, if or when a pinch bar comes into contact with an electrical current, the pinch bar user or operator can be shocked and severely injured and possibly killed. While pinch bar operators often wear protective clothing, such as electrically insulated gloves, if the pinch bar operator inadvertently forgets to wear his or her gloves, or a hole develops in the glove material after repeated use, the pinch bar operator could be injured by coming into contact with an electrically charged pinch bar. Moreover, because certain environments may be subject to intermittent or unpredictable electrical charges, such as manholes which may or may not be electrically charged due to stray voltage, a pinch bar operator may become careless over time and fail to consistently take the necessary safety precautions, including wearing insulated gloves.

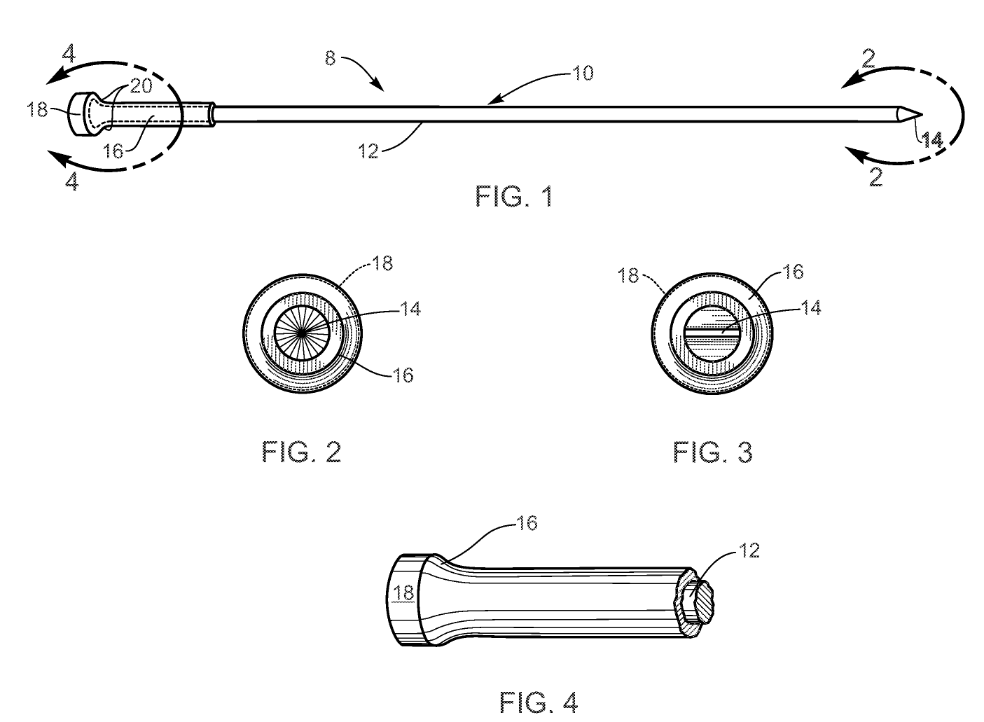

The present application describes insulated pinch bars that can be used to provide consistent and adequate protection to the pinch bar operator in the event the pinch bar accidentally comes into contact with an electrical current during operation. While the insulated pinch bar can comprise any suitable component that allows it to provide this insulating function, FIG. 1 shows some embodiments in which an insulated pinch bar 8 comprises a pinch bar 10 and an electrically insulative material 16.

Pinch bar 10 can be used for any known purpose. In some embodiments, the pinch bar 10 is repeatedly used and reused to drive a series of exploratory holes through a surface, including paved surfaces, such that access is provided to a desirable depth of the subsurface. Pinch bar 10 can therefore be used to facilitate the placement of sensors at depth in order to take subsurface measurements or readings, such as gas leak measurements. In such embodiments, pinch bar 10 can be further used to ream or otherwise enlarge the exploratory holes in order to accommodate placement and/or subsequent removal of the sensors.

In other embodiments, the pinch bar 10 can be used as a lever to physically manipulate the location or orientation of an object. In these embodiments, pinch bar 10 effectively magnifies the moment or torque generated by an externally applied force by providing an extended or lengthened moment arm such that heavy objects can be shifted through the application of a relatively modest force.

In some embodiments, the pinch bar 10 includes a longitudinal body 12, a distal tip 14, and a proximal head 18. In such embodiments, pinch bar 10 can made of any known material consistent with those functions described above. Some examples of such materials include metallic materials, such as steel, tungsten, cobalt, iron, aluminum, copper, brass and other metallic materials, including alloys and/or combinations thereof. Additional examples of such materials include composite materials. In some configurations, each component of pinch bar 10, including longitudinal body 12, distal tip 14 and proximal head 18, can be constructed out of a uniform or homogeneous material. For example, longitudinal body 12, distal tip 14 and proximal head 18 can each be constructed out of uniform steel alloy. In other configurations, however, some or all of the discrete components that make up pinch bar 10 can be constructed out of different materials or materials having different physical properties or characteristics. For example, longitudinal body 12 might be constructed out of mild steel while proximal head 18 can be constructed out of hardened or heat-treated steel. In a further example, distal tip 14 might be constructed out of carbide or like materials adapted to maintain structural integrity or resist wear over extended periods of use or the application of variable and/or intermittent loads.

In some configurations, some of the discrete components of pinch bar 10, such as distal tip 14, can be made to wear out at an increased rate in order to preserve or enhance the longevity of other components, such as longitudinal body 12. In such configurations, the part adapted to sustain greater wear, or the consumable part, is replaceable.

The pinch bar 10 can be constructed, made or formed using any known method. In some embodiments, however, the material selected dictates the method of construction. For example, in those embodiments of pinch bar 10 having uniform or homogeneous discrete components, pinch bar 10 can be constructed using an appropriate method such as casting, forging, molding, milling, extruding and other methods where pinch bar 10 is formed as a single homogeneous element. In other embodiments, such as where the discrete component parts of pinch bar 10 are comprised of different or dissimilar materials, the component parts of pinch bar 10 can be assembled and combined or joined to one another using alternative suitable methods, such as welding, brazing, soldering, gluing, and other methods for joining similar or dissimilar components together to form a whole.

Where the pinch bar 10 contains consumable components, the consumable component can be connected to the whole by a method that permits replacement once the consumable component sustains sufficient wear. For example, longitudinal body 12 and proximal head 18 may be made from mild steel while distal tip 14 is made from carbide. In this example, longitudinal body 12 and proximal head 18 can be formed by one process, such as welding two appropriately dimensioned pieces of stock material together. Distal tip 14 can then be affixed to the distal end of longitudinal body 12 by brazing or gluing. In this way, as pinch bar 10 is used over a sufficient length of time, or after sufficient wear has occurred, distal tip 14 can be removed and replaced. By way of illustration, where the pinch bar 10 is used to penetrate a surface, such as a paved surface for example, the distal tip 14 can become dull over time. Accordingly, by making distal tip 14 removable and replaceable, a user can avoid the cost of replacing the entire pinch bar once distal tip 14 becomes dull since the distal tip 14 alone can be replaced as necessary. In alternative embodiments, distal tip 14 can be sharpened, repaired or otherwise re-forged in order to effectively replace distal tip 14 without necessitating replacement of the entire pinch bar, even where distal tip 14 is not removable.

Pinch bar 10 can be configured to be used with other devices (not shown) known in the art. For example, pinch bar 10 can be used with manual or automated means for placing the pinch bar in a desired location, such as a manual hammer (e.g., a sledge hammer) or an automated hammer (e.g., a jack hammer or other hydraulic devices). As a further example, pinch bar 10 can be used with an extraction mechanism to remove pinch bar 10 from a particular location. By way of illustration, where pinch bar 10 is used to penetrate a surface, such as a paved surface for example, a sledge hammer can be used to drive the sledge hammer into or through the paved surface while an extraction mechanism is used to retrieved pinch bar 10 from the paved surface leaving a hole in the pavement open and accessible. In such instances, pinch bar 10 can be enhanced or adapted in any suitable way to facilitate its use with such devices.

The longitudinal body 12 of the pinch bar 10 can be configured with any length and diameter consistent with its use. The actual dimensions may, and often will, vary depending on the intended use of the pinch bar 10. For example, in applications where pinch bar 10 is used to drive a hole into a surface, such as a paved surface, longitudinal body 12 can be any suitable length and diameter to achieve the desired depth of the hole while still leaving enough of pinch bar 10 exposed at the surface to efficiently grip and remove pinch bar 10 from the hole. In another example, where pinch bar 10 is used as a lever to manipulate the location or orientation of a second object, the length and diameter of longitudinal body 12 can be selected in order to provide sufficient leverage for the user to apply force without compromising the bending integrity of pinch bar 10. In some embodiments, the appropriate length of longitudinal body 12 will be dictated by other concerns known to those of skill in the art based on the intended application of pinch bar 10. Alternative considerations, such as the structural integrity of pinch bar 10, will dictate the suitable length and width of longitudinal body 12.

The longitudinal body 12 has any desirable or suitable cross-sectional shape. Some examples of suitable cross-sectional shapes include shapes (which may vary along the length) that are circular, ellipsoidal, square, rectangular, triangular, hexagonal, octagonal, polygonal, irregular, or combinations thereof. Additionally, where longitudinal body 12 is shaped to have corners (e.g., where longitudinal body 12 is square, rectangular, etc.), the corners can come to a point, can be rounded or chamfered. By way of illustration, FIGS. 2 and 3 show some embodiments in which longitudinal body 12 is substantially circular at the cross-section A-A.

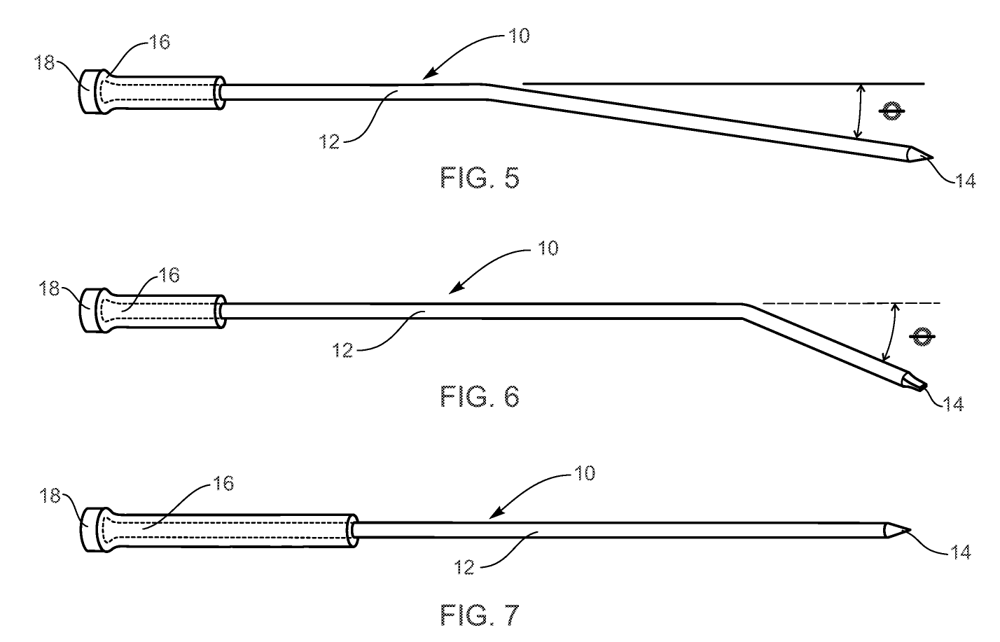

As shown in FIG. 1, longitudinal body 12, and by extension pinch bar 10, can substantially linear or straight along its entire length in some configurations. Such a configuration is appropriate where the pinch bar is intended to be driven by axial force into a surface. In other embodiments, however, as illustrated in FIGS. 5 and 6, longitudinal body 12 can be bent in one or more locations at an angle 0 relative to the longitudinal axis of pinch bar 10. Such bends can be located anywhere along the length of longitudinal body 12. Such a configuration is appropriate and beneficial where the pinch bar is intended to be used as a lever or leveraging device.

The distal tip 14 can have any number of configurations. FIGS. 2 and 3 illustrate embodiments where the distal tip 14 can be conical or tapered uniformly such that at its proximal end it has substantially similar cross-sectional dimensions as longitudinal body 12 while its distal end the cross-sectional dimensions can be reduced. Thus, the distal point of distal tip 14 terminates in a relatively sharp fulcrum that is visibly pointed to the naked eye. In such embodiments, the taper, rake or pitch defined by the hypotenuse length and the angle defined at the point of distal tip 14 may be selected according to considerations of use. For example, the pitch of distal tip 14 can be governed by frictional considerations in order to ensure that pinch bar 10 may be driven into a surface in the most efficient manner, with the least amount of force, and with minimal damage to the surrounding environment.

FIG. 3 shows some embodiments where the distal tip 14 terminates in other shapes. In some embodiments, as illustrated in FIG. 3, the distal tip 14 can terminate in a flat shape having a length and a width akin to a flat head screwdriver, a chisel or a wedge. In other embodiments, distal tip 14 can terminate in any desirable shape having any desirable dimensions, such as a triangle, a star, a square, a hexagon and so forth. In this way, distal tip 14 can serve dual functions. For example, distal tip 14 could serve as a key to unlock a manhole cover while, as part of pinch bar 10 as a whole, distal tip 14 can simultaneously serve as the point at which leverage is applied to remove the manhole cover. Alternatively, the shape of distal tip 14 could permit pinch bar 10 to serve in a similar fashion to a traditional chisel device.

The proximal head can have any number of configurations. In some embodiments, the proximal head 18 can be adapted to transmit axial force applied by an external device to pinch bar 10. In other words, proximal head 18 contains the portion of pinch bar 10 that a user would strike to drive pinch bar 10 into place. In such embodiments, the proximal head 18 is effectively just the proximal surface of longitudinal body 12, having the same cross-sectional dimensions as longitudinal body 12. In other embodiments, however, proximal head 18 can have cross-sectional dimensions that exceed those of longitudinal body 12. In this way, the surface area of proximal head 18 can be increased or enlarged such that a user's ability to consistently and effectively strike the sweet spot of proximal head 18 is maximized. By way of illustration, some embodiments of proximal head 18 having a larger cross-sectional area than longitudinal body 12 are depicted at FIG. 4. Where the proximal head 18 has a larger cross-sectional area than longitudinal body 12, these embodiments can also result in a flange at the junction of proximal head 18 and longitudinal body 12. In this way, the flange at the junction of proximal head 18 and longitudinal body 12 can enhance the ability to extract pinch bar 10 from a hole as discussed above. In some embodiments, the flange at the junction of proximal head 18 and longitudinal body 12 can serve additional functions, such as enhancing the gripping surface of pinch bar 10 when the pinch bar is used as a lever.

The electrically insulative material 16 shown in FIG. 1 can comprise any known electrically insulative material. Some examples of suitable electrically insulative materials include glass, paper, Teflon®, rubber, rubber elastomers, nylon, polymers, plastic, porcelain, composite materials, ceramic, polyvinyl chloride, polyolefin, fiberglass, silicone, silicone rubber, aramid fiber paper, polyester, polyimide, laminates, fluoropolymers, Viton®, polyvinylidene fluoride, fluorinated ethylene propylene, and combinations thereof.

In some embodiments, the material selected for electrically insulative material 16 will depend on the intended use of the insulated pinch bar 8. For example, where voltage is relatively low or moderate, rubbers and polymers may be used. On the other hand, where voltage is expected to be relatively high, better insulative material, such as Teflon, can be used. In some utility applications, where insulated pinch bar 8 may come into contact with standard metropolitan electrical utility lines, protection against 10,000 volts or more can be used.

To achieve a desirable level of electrical protection, in some embodiments the electrically insulative materials listed above may be employed in multiple layers to form electrically insulative material 16. Alternatively, the electrically insulative materials listed above may be manufactured with thicker walls, such as dual or triple walls, to increase the level of electrical protection derived from electrically insulative material 16. In some embodiments, the thickness of the electrically insulative material 16 can range from about ⅛ to about ¼ of an inch.

Depending on the level of protection provided by electrically insulative material 16, in some embodiments the electrically insulative material 16 can be color coded so that users can determine by a quick, or even cursory, visual inspection what level of protection the insulated pinch bar 8 provides. In this way, the safety of the user can be enhanced by avoiding contact with pinch bars that visibly would not provide sufficient protection if subject to a given level of electrical current. For example, electrically insulative material 16 could be coded with an orange color to denote protection against 10,000 volts, red for protection against 12,000 volts, and so forth.

The electrically insulative material 16 can be applied or disposed about a portion of the pinch bar (i.e., longitudinal body 12) by any known method. In some embodiments, the insulated pinch bar 8 can be manufactured with the electrically insulative material 16 in the desired location. In other embodiments, the electrically insulative material 16 can be applied to the pinch bar after it has been manufactured. Some suitable methods for disposing, coating, covering, affixing, treating, or otherwise applying one or more layers of electrically insulative material 16 to pinch bar 10 include configuring a suitable electrically insulative material selected from the list provided above in paragraph 32 as cold shrink tubing, heat shrink tubing, independent sheets, strips or sleeves, or as a liquid which cures, solidifies, congeals, hardens or otherwise forms a solid via chemical reaction upon application or shortly thereafter.

In some embodiments, electrically insulative material 16 can be configured as cold shrink tubing. Cold shrink tubing is an open ended sleeve comprised of an electrically insulative material which has been factory expanded or pre-stretched and assembled onto a supporting removable plastic core. The cold shrink tubing of electrically insulative material 16 can be disposed circumferentially about a portion of longitudinal body 12 such that electrically insulative material 16 abuts proximal head 18. The cold shrink electrically insulative material 16 can be secured to longitudinal body 12 by removing or unwinding the supporting plastic core such that the sleeve collapses down or contracts on pinch bar 11.

In other embodiments, the electrically insulative material 16 can be configured as heat shrink tubing. Heat shrink tubing is an open ended sleeve comprised of an electrically insulative material which shrinks upon the application of heat. In these embodiments, the heat shrink electrically insulative material 16 can be disposed circumferentially about a portion of longitudinal body 12 such that electrically insulative material 16 abuts proximal head 18. The heat shrink electrically insulative material 16 can be secured the longitudinal body 12 by applying heat to the heat shrink tubing such that the sleeve collapses down or contracts on pinch bar 10.

In yet other embodiments, the electrically insulative material 16 can configured as independent sheets, strips or sleeves. In these embodiments, the sheets, strips or sleeves of electrically insulative material 16 can be disposed about a portion of longitudinal body 12 such that electrically insulative material 16 abuts proximal head 18. The sheets, strips or sleeves of electrically insulative material 16 can be secured to the longitudinal body 12 by applying adhesives and the like such that the independent sheets, strips or sleeves adhere to pinch bar 10.

In still other embodiments, electrically insulative material 16 can be configured as a liquid which cures, solidifies, congeals, hardens or otherwise forms a solid via chemical reaction upon application or shortly thereafter. In such embodiments, the electrically insulative material 16 can be disposed, in liquid form, about a portion of longitudinal body 12 such that electrically insulative material 16 abuts proximal head 18. For example, pinch bar 10 can be dipped into electrically insulative material 16 while in liquid form. Thereafter, the electrically insulative material 16 can be secured to pinch bar 10 merely by allowing the chemical reaction to cure the electrically insulative material 16 such that it solidifies, congeals, hardens or otherwise forms a solid and adheres to the surface of pinch bar 11.

In the embodiments illustrated in FIG. 1, electrically insulative material 16 is disposed circumferentially about a portion of longitudinal body 12 of pinch bar 10. It should be noted that the term circumferentially does not denote and is not limited solely to a circular connotation. Rather, is some embodiments, circumferentially can be intended to mean that the electrically insulative material 16 is disposed around the entire perimeter or outside surface of a portion or select length of longitudinal body 12. In some embodiments, the electrically insulative material 16 abuts proximal head 18. In these embodiments, the electrically insulative material 16 can abut only the distal face of proximal head 18 while in other embodiments (see FIG. 4), electrically insulative material 16 wraps over the distal external edge or lip of proximal head 18 such that electrically insulative material 16 forms a “funnel” shape wherein the distal external lip of proximal head 18 is encompassed or enclosed by electrically insulative material 16. In this way, if a user is holding the insulated pinch bar 8 at electrically insulative material 16 and his or her hands slide proximally, the user's hands will not come into contact with the distal face of proximal head 18 such that the user remains protected from electrical shock under such circumstances. In other embodiments, however, the electrically insulative material 16 need not abut the proximal head 18.

In some configurations, the electrically insulative material 16 can double as a handle to enhance the gripping surface of pinch bar 10. For example, the insulative material 16 can be textured or layered, dispose or applied in such a way as to produce a texture. In this way, additional frictional contact area is provided on insulated pinch bar 8 so that the pinch bar operator's hands are less likely to slip and thereby inadvertently come into contact with an electrically charged surface during operation of the pinch bar.

The electrically insulative material 16 can have any suitable dimensions. In some embodiments, the electrically insulative material 16 can have a length larger than the length of two human hands placed linearly adjacent to one another. In this way, a user can grab insulated pinch bar 8 with both hands during use while remaining protected from electrical shock. Accordingly, in some configurations, the electrically insulative material 16 is approximately six inches (6″) to two feet (2′) in length. In other embodiments, however, a larger (see FIG. 7) or smaller portion or length of longitudinal body 12 may be covered by electrically insulative material 16 according to the intended use of insulated pinch bar 8. Indeed, in some embodiments, the entire length of longitudinal body 12 can be covered, treated or otherwise coated with electrically insulative material 16. In such embodiments, some portions of electrically insulative material 16 are textured to enhance the user's grip, as discussed above, while other portions are adapted to reduce friction with a contact surface, such as pavement.

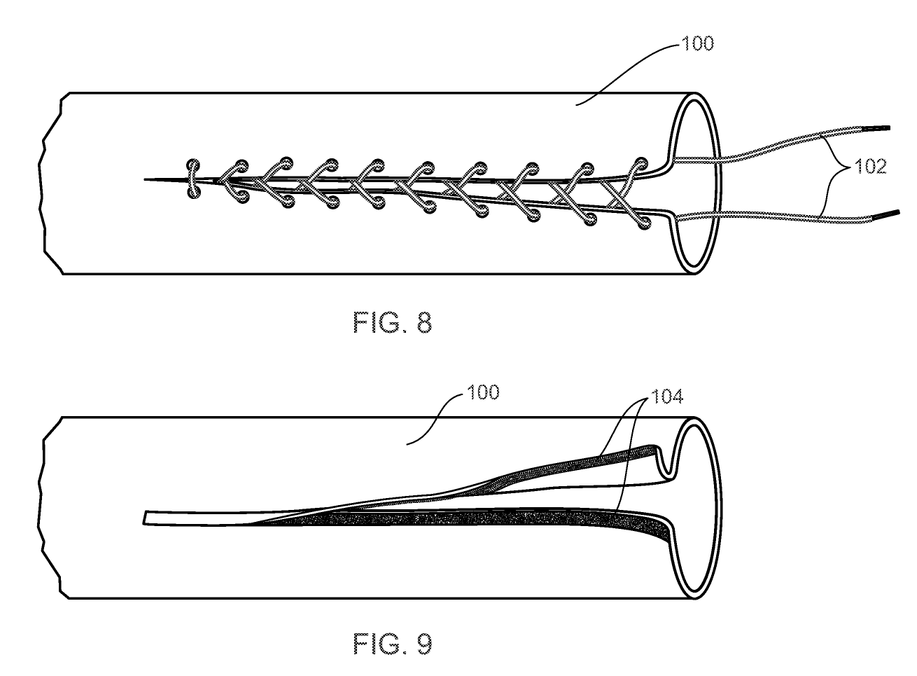

Some of the electrically insulative materials may be fragile (e.g., rubber, plastic, etc.) which can be marred or otherwise destroyed in whole or in part, thereby eliminating the benefit of such material while simultaneously giving the user a false sense of security. Accordingly, as shown in FIGS. 8 and 9, some embodiments of an insulated pinch bar system have an insulated pinch bar 8 and an insulated pinch bar cover 100. The cover 100 may be made of any material which will provide protection against marring or other damage for electrically insulative material 16 when insulated pinch bar 8 is not in use. Some examples of suitable protective materials include canvas, or other heavy, closely woven fabrics, rubber, foam, neoprene, similar materials having durable or shock absorbent qualities, and combinations thereof. In some embodiments, cover 100 can be of sufficient length to entirely cover electrically insulative material 16 when in place.

In order to retain, restrain or otherwise secure cover 100 in the desired location or position relative to electrically insulative material 16, the cover 100 can include various restraining devices or mechanisms. In these embodiments, the cover 100 can laced shut with drawstring 102, while in other embodiments the cover 100 can be closed and secured via mated Velcro® strips 104. In such embodiments, snaps, buttons, or other fasteners could replace Velcro strips 104 to accomplish the same result. In yet other embodiments, cover 100 does not have a slit that needs to be closed; rather, cover 100 is akin to a sock having one open end. In such embodiments, a drawstring is fitted around the open end of cover 100 such that the open end may be tied shut around electrically insulative material 16. In other embodiments, the open end of the “sock” type cover 100 is fitted with elastic such that a user can stretch the end of cover 100 open in order to place the cover over electrically insulative material 16 and then simply allow cover 100 to contract under the elastic tension. In this way, the longevity of electrically insulative material 16 is enhanced and the level of electrical protection provided thereby is prolonged. Cover 100 can be selectively removable and replaceable.

By coating, covering, treating, or otherwise insulating the pinch bar 10 with electrically insulative material 16, insulated pinch bar 8 can provide consistent and adequate electrical protection to the pinch bar operator in the event the pinch bar accidentally comes into contact with an electrical current during operation. For example, metallic manhole covers can carry an electrical charge or current due to stray voltage or electrical current generated from poorly grounded utilities. If a pinch bar is used to remove an electrically charged manhole cover, the user could be shocked and suffer severe injuries, including death because of the electrical current. Likewise, when pinch bars are used to drive exploratory holes into a pavement surface, it is possible for the pinch bar to be inadvertently driven into a subsurface electrical line subjecting the pinch bar operator to severe electrical injuries, including death. Thus, the insulated pinch bar can be used in a wide variety of construction projects, including public, industrial, or individual.

In addition to any previously indicated modification, numerous other variations and alternative arrangements may be devised by those skilled in the art without departing from the spirit and scope of this description, and the appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, the examples and embodiments, in all respects, are meant to be illustrative only and should not be construed to be limiting in any manner.

1. An insulated pinch bar, comprising:
a pinch bar having a longitudinal body, a distal tip, and a proximal head; and
an electrically insulative material disposed about a portion of the longitudinal body so that it is located near the proximal head.

2. The insulated pinch bar of claim 1, wherein a distal lip of the proximal head is covered by the electrically insulative material.

3. The insulated pinch bar of claim 1, wherein a cross-sectional area of the proximal head exceeds a cross-sectional area of the longitudinal body.

4. The insulated pinch bar of claim 1, wherein the longitudinal body is substantially linear.

5. The insulated pinch bar of claim 1, wherein a portion of the electrically insulative material is textured.

6. The insulated pinch bar of claim 1, wherein the electrically insulative material is color coded according to a level of electrical protection provided by the electrically insulative material.

7. The insulated pinch bar of claim 1, wherein the electrically insulative material abuts the proximal head.

8. The insulated pinch bar of claim 1, wherein the electrically insulative material partially covers the proximal head.

9. An insulated pinch bar system, comprising:
a pinch bar having a longitudinal body, a distal tip, and a proximal head, and an electrically insulative material disposed about a portion of the longitudinal body so that it is located near the proximal head; and
a cover configured to be placed over the electrically insulative material during periods when the insulated pinch bar is not in use.

10. The system of claim 10, wherein the cover contains a device for securing the selectively removable cover in a position relative to the electrically insulative material.

11. The system of claim 10, wherein the cover is removable.

12. The system of claim 10, wherein a distal lip of the proximal head is covered by the electrically insulative material.

13. The system of claim 10, wherein a portion of the electrically insulative material is textured.

14. The system of claim 10, wherein the electrically insulative material is color coded according to a level of electrical protection provided by the electrically insulative material.

15. The system of claim 10, wherein the electrically insulative material abuts the proximal head.

16. The system of claim 10, wherein the electrically insulative material partially covers the proximal head.

17. A method for electrically insulating a pinch bar, comprising:
providing a pinch bar having a longitudinal body, a distal tip, and a proximal head; and
disposing an electrically insulative material about a portion of the longitudinal body so that it is located near the proximal head.

18. The method of claim 17, further comprising covering a distal lip of the proximal head by the electrically insulative material.

19. The method of claim 17, further comprising texturing a portion of the electrically insulative material.

20. The method of claim 17, further comprising color coding the electrically insulative material according to a level of electrical protection provided by the electrically insulative material.

21. The method of claim 17, further comprising abutting the electrically insulative material to the proximal head.

22. The method of claim 17, further comprising partially covering the proximal head with the electrically insulative material.
